(19) United States
(12) Patent Application Publication
(10) Pub. No.: US 2009/0049877 A1
(43) Pub. Date: Feb. 26, 2009

(54) Universal steering wheel lock

(76) Inventor: Eduardo D'Angelo, Miami, FL (US)

Correspondence Address: Laurence J. Edson;Ste. 300, 2514 Hollywood Blvd., Hollywood, FL, 33020, US

(21) Appl. No.: 12/221,347

(22) Filed: Aug. 2, 2008

Related U.S. Application Data
(60) Provisional application No. 60/965,976, filed on Aug. 23, 2007.
(60) Provisional application No. 61/011,609, filed on Jan. 18, 2008.
(60) Provisional application No. 61/134,801, filed on Jul. 14, 2008.

(51) Int. Cl. B60R 25/02

(52) U.S. Cl. 70/209

(57) ABSTRACT

A steering wheel lock having a triple hook, a bar receiving mechanism, a lock box, a bar fixable to the lock box, and a lock is disclosed. The triple hook, via its lock box attaches to the steering wheel of a vehicle and is secured with the lock, which is attached with the bar. The length of the bar is adjusted within the lock box to provide a tight and secure fit customized to the particular dimensions of the steering wheel. A blinking LED alerts a passerby that the lock is engaged.

This application claims priority of U.S. Provisional application No. 60/965,976 filed Aug. 23, 2007 to Eduardo D'Angelo for Universal Steering Wheel Lock, U.S. Provisional application No. 61/011,609 filed Jan. 18, 2008 to Eduardo D'Angelo for Universal Steering Wheel Lock, and U.S. Provisional application No. 61/134,801 filed Jul. 14, 2008 to Eduardo D'Angelo for Universal Steering Wheel Lock.

### BACKGROUND OF THE INVENTION

1. Introduction

Cars are expensive, but certain factors limit their appeal to thieves. For example, a big lock on the steering wheel makes stealing difficult requiring significant time and effort. Also, a thief can see the big lock, and move to another less challenging car to steal. Finally, motors might be somewhat distinctive, bearing serial numbers or other indicia. Consequently, thieves have found a more favorable risk to reward ratio in just stealing the parts of the motor.

Most car steering wheels have three sections: a horn at the center of the wheel, a circular wheel section, where a driver grips and steers the car, and at least one arm joining the center to the circular wheel section.

If the steering wheel can be fixed in place, and its unauthorized movement restricted, then the car cannot be removed.

2. Field of the Invention

The present invention relates to a lock for securing the steering wheel of a motor vehicle to prevent the movement of the wheel, thereby preventing unauthorized operation of the vehicle.

3. Description of the Prior Art

Motor vehicle security devices are disclosed in U.S. Patents. U.S. Pat. No. 5,653,133, to Passantino teaches a steering wheel and brake-locking device for road vehicles. Passantino's lock is installed between the brake and the steering wheel.

U.S. Pat. No. 5,555,753 to Matlock teaches a vehicular anti-theft steering wheel lock. Matlock's lock primarily surrounds and immobilizes vehicle steering wheels with a rigid circular pan that surmounts the steering wheel and overlies the steering column.

U.S. Pat. No. 5,267,458 to Heh teaches a lock that hooks on to a steering wheel, and the vehicles brake. Here again, the brake serves as an anchor preventing the movement of the steering wheel via a rigid member.

U.S. Pat. No. 4,738,127 to Johnson is a patent directed toward an automobile steering lock.

### BRIEF SUMMARY OF THE INVENTION

It is an object of the present invention to prevent the unauthorized operation of a motor vehicle.

Another object of the present invention is to provide a lock that will prevent the movement of the steering wheel of a vehicle.

A further object of the present invention is to provide a lock that can draw attention by continuously flashing an LED.

A further object of the present invention is to provide a lock that will sound the vehicles horn if one attempts to remove the lock without a key.

Yet another objective is to provide a lock that allows one-time fine adjustment to provide a customized, tight fit for a unique steering wheel,

These and other objects of the invention are accomplished by providing a steering wheel lock having a triple hook, a bar, and a lock. The triple hook abuts the steering wheel, and the bar fixes the lock to the triple hook and the steering wheel.

Other objects and further scope of applicability of the present invention will become apparent from the detailed description given hereinafter. However, it should be understood, that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE SEVERAL VIEWS OF THE DRAWING

The present invention will be better understood from the detailed description given herein below and the accompanying drawings with which are given by way of illustration only.

FIG. 1A is a perspective view of the lock of the present invention.

FIG. 1B is a perspective view of an alternative embodiment of the lock of the present invention.

FIG. 2 is a view from the vehicle window showing the triple hook and lock box of the present invention attached to a steering wheel.

FIG. 3 is a perspective view of the lock box of the present invention.

FIG. 4 is a view of the stopper and stopper knob of presently claimed invention.

FIG. 5 is a view of a bar for the presently claimed invention.

FIG. 6 is a view of a lock box, stopper and a portion of the bar for the presently claimed invention.

FIG. 7 is a cross-sectional view of a lock box with the stopper and bar inserted for the presently claimed invention.

FIG. 8 is a transparent view of a lock for the presently claimed invention showing internal cavities.

FIG. 9 is another transparent view of a lock for the presently claimed invention showing additional cavities.

FIG. 10 is a cross-sectional view of a lock for the presently claimed invention showing a key lock mechanism.

FIG. 11 is a cross-sectional view of a lock with a bar inserted for the presently claimed invention.

FIG. 12 is a close-up, cross-sectional view of a lock for the presently claimed invention showing the interaction between the lock and a bar.

FIG. 13 is a view of an unlocked lock for the presently claimed invention illustrating the wiring schematic for an LED warning system.

FIG. 14 is a view of a locked lock for the presently claimed invention illustrating the wiring schematic for an LED warning system.

FIG. 15 is a view of the presently claimed invention attached, and unlocked.

FIG. 16 is a view of the presently claimed invention attached, and locked.

FIG. 17 is a perspective view of the presently claimed invention installed on a steering wheel.

FIG. 18 is a cross-sectional view of the lock for the presently claimed invention.

FIG. 19 is a view of an alternative embodiment the presently claimed invention with the bar attached to the lock box and in-line with the triple hook.

FIG. 20 is a view of an adjustment screw with a truncated area of the presently claimed invention.

FIG. 21 is a view of an adjustment screw with a rectangular bar of the presently claimed invention.

FIG. 22 is a view of another embodiment of the presently claimed invention from the side.

FIG. 23 is an environmental view of another embodiment of the presently claimed invention.

### DETAILED DESCRIPTION OF THE INVENTION

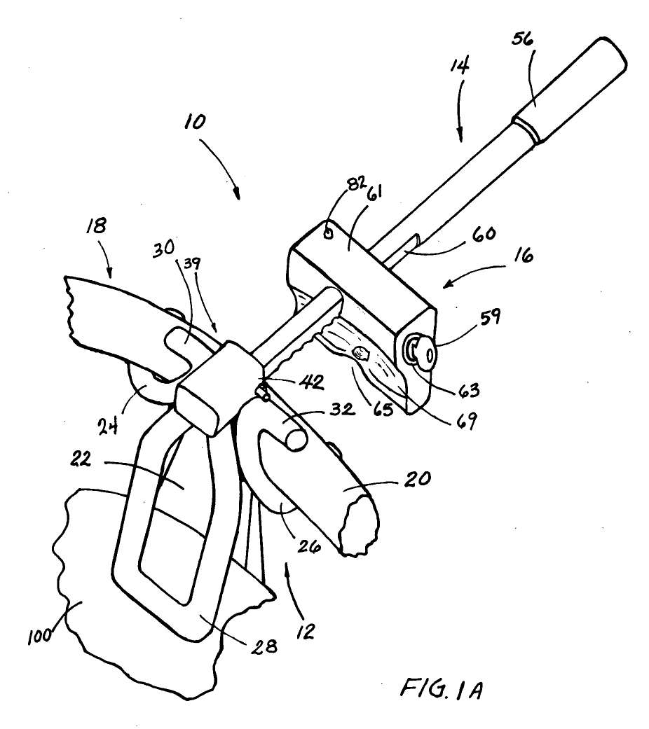

A Universal Steering Wheel Lock of the presently claimed invention is illustrated in FIG. 1A and designated generally by reference numeral 10. With reference now to the drawings and in particular to FIG. 1A, the steering wheel lock has three basic components: a triple hook 12, a bar 14 and a lock 16. FIG. 1B shows an alternative embodiment of the invention in which the truncated area of the bar remains in contact with the lock and the lock box, but the remaining portion of the bar attaches to the lock box and is aligned with the bended bar 28 of the triple hook, as explained below.

The Universal Steering Wheel Lock locks the steering wheel 18 of a vehicle. A conventional steering wheel 18 is formed by the circular wheel section 20 and at least one arm 22 attached at the end to the circular wheel section 20 and to the center of the steering wheel at the other end.

The triple hook 12 has first and second U-shape hooks 24, 26 and a bended bar 28. The U-shaped hooks 24, 26 wrap around the wheel section of the steering wheel 20. The bended bar 28 attaches between the first and second U-shaped hooks 24, 26, and abuts the horn 100.

The shape of the bended bar 28 is shown in FIG. 1. The U-shaped hooks 24, 26 respectively have first and second ends 30, 32. This shape allows hooking up the circular wheel section 20 with the first and second ends 30, 32 and the U-shaped hooks 24, 26. The bended bar 28 assures a tight fit with the arm 22. The first and second ends 30, 32 belong to first and second U-shaped hooks 24, 26 and follow the arc shape of the circular wheel section 20.

The triple hook 12 includes a bar receiving mechanism 39 as illustrated in FIGS. 1, 2 and 3. The bar receiving mechanism 39 features a lock box 42 attached to first and second ends 30, 32 of first and second U-shaped hooks 24, 26 and to the bended bar 28. As illustrated in FIG. 15, the bar receiving mechanism 39 is positioned approximately 70 degrees in reference with the side of the bended bar 28 directly opposite the steering wheel 18 to compensate the inclination of the steering wheel 18 in a vehicle.

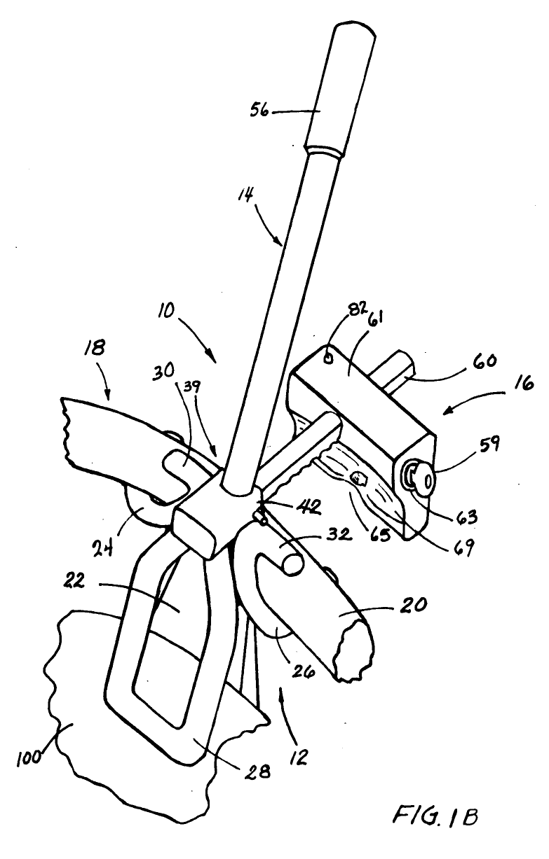

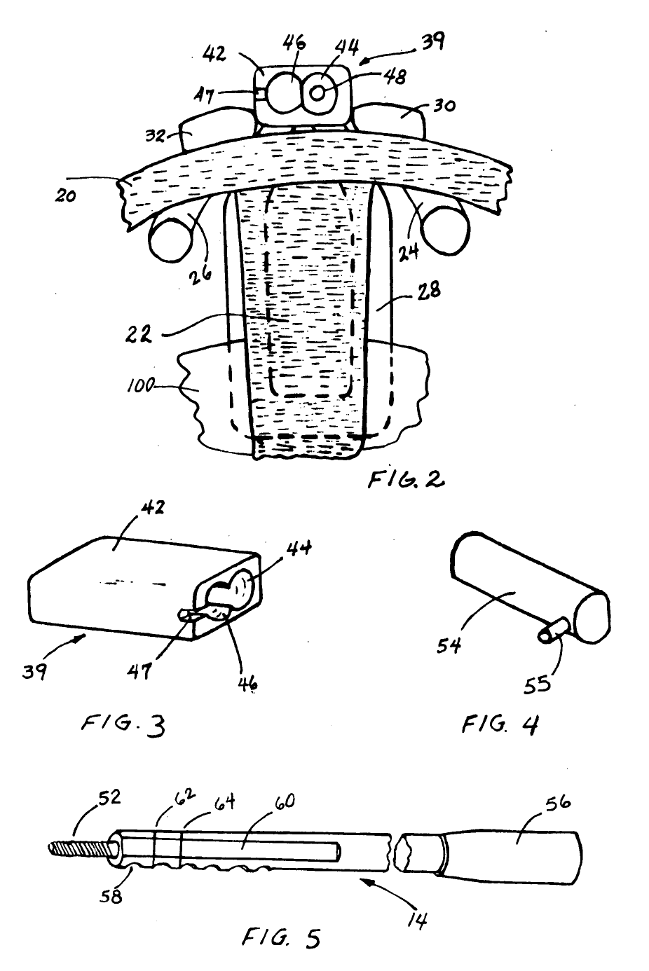

The lock box 42 has a bar cavity 44, a stopper cavity 46 and a stopper knob cavity 47 as illustrated in FIGS. 2 and 3. As seen in FIG. 7, the bar cavity 44 has an internal threaded orifice 48 abutting the bar cavity along its longitudinal axis. FIG. 4 shows a stopper 54 having a stopper knob 55 perpendicular at one end of the stopper 54. The stopper 54 and stopper knob 55 having such size an dimension to substantially fill the stopper cavity 46 and a stopper knob cavity 47.

The triple hook 12 is normally made of metal mainly hardened steel covered with a rubber finish to avoid any damage to the steering wheel 18.

There is a bar 14 as illustrated in FIG. 1 and FIG. 5. The bar 14 has at one end a screw shape 52 with a thread to be screw up in the bar cavity 44 gradually until the desire position, as illustrated in FIG. 7.

The stopper 54 is inserted in the stopper cavity 46 to prevent the rotational moving of bar 14 inserted in the bar cavity 44 when has reached the desire position. This function will be described in detail later.

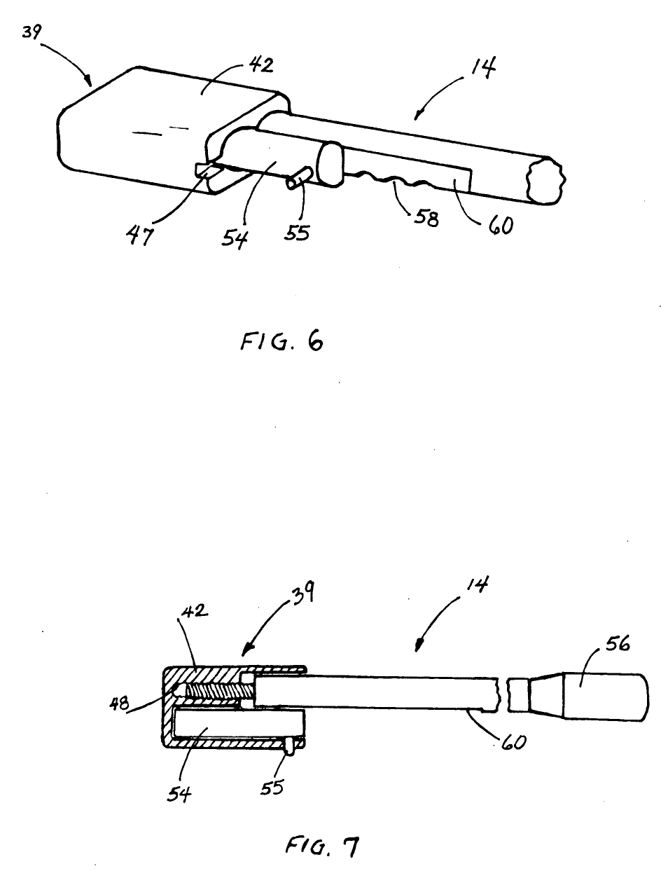

The stopper 54 has a small knob 55 as illustrated in FIG. 4 to allow manual removal of the stopper 54 from the stopper cavity 46. This knob 55 is inserted in the stopper knob cavity 47 when the bar 14 is locked in the desire position as illustrated in FIGS. 6 and 7.

The bar 14 is illustrated in detail in FIG. 5. The end of bar 14 has a screw shape 52 already described. The other end of bar 14 has a rubber grip 56 to cover the bar 14 avoiding any damages in the dashboard 98 and front window 102 of the vehicle, as illustrated in FIG. 17.

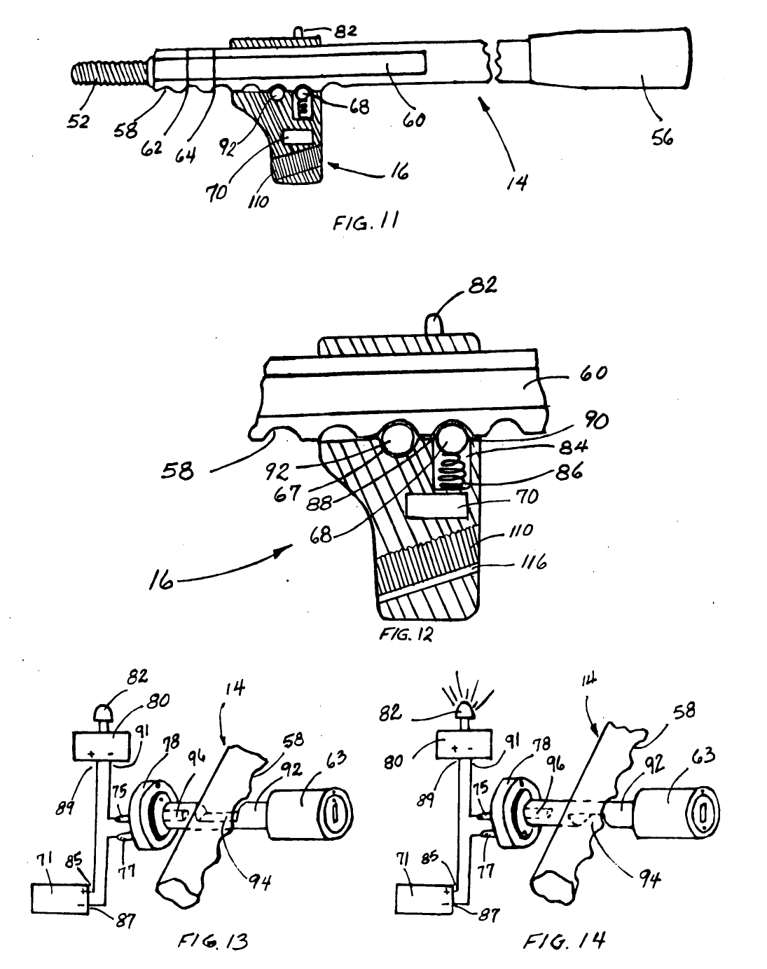

FIGS. 5 and 6 show the bar 14 has at the bottom different tooth creating a sequence of shallow ridges 58 used in the locking mechanism of FIGS. 13 and 14. The bar 14 has a truncated area 60 in the left side of the bar 14 located in the sequence of shallow ridges 58 as illustrated in FIG. 5. The bar 14 has first and second marks 62, 64. Both of them will be explained later.

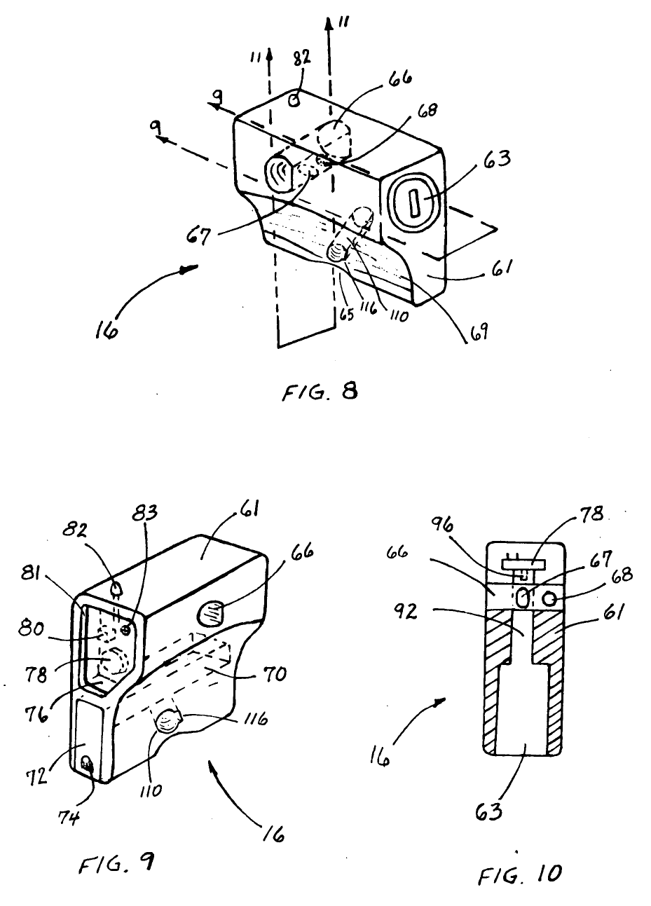

The lock 16 is illustrated in FIGS. 8, 9 and 10. The lock 16 features a lock housing 61 having a key lock mechanism 63, a truncated hole 66, a case 70 and an indicator recess 76 as illustrated in FIG. 9. The truncated hole 66 has a spherical bearing 68 and an opening 67 as illustrated in FIG. 8 and FIG. 10. The truncated hole 66 allows to pass the bar 14.

The lock 16 has a curved impression 69 to accommodate the circular wheel section 20-of the steering wheel and a dimple 65 to accommodate the arm 22.

The case 70 is designed to hold the batteries 71. The case 70 has a lid 72 able to slide when it is moved using the groove 74, allowing removing the batteries 71 from the case 70 as illustrated in FIG. 9.

The indicator recess 76 comprises a rotary switch 78, a switch circuit 80 and a LED 82. The indicator recess 76 has a lid 81 and a screw 83 to close the indicator recess 76.

The interaction between the bar 14 and the lock 16 is illustrated in FIGS. 11 and 12. The bar 14 is inserted in the lock 16 through the truncated hole 66.

The lock 16 has a spring cavity 84. The spring cavity 84 accommodates a spring 86 and a spherical bearing 68. The spring cavity 84 has a set of flanges 88, 90 to avoid the exit of the spherical bearing 68 from the spring cavity 84.

The key lock mechanism 63 has a prolongation bar 92 as illustrated in FIGS. 13 and 14. The prolongation bar 92 comprises a prolongation bar recess 94. The opening 67 allows to interact the prolongation bar 92 belong to the lock mechanism 63 with the sequence of shallow ridges 58 of the bar 14. The prolongation bar recess 94 allows the bar 14 to slide through the truncated hole 66 when the prolongation bar recess 94 is in the position illustrated in FIG. 13. In this illustration the bar 14 is unlocked.

The prolongation bar 92 has a rotary switch cavity 96 at the end with a half moon shape to insert the half moon bar belongs to the rotary switch 78.

The rotary switch 78 has first and second switch contacts 75, 77 as illustrated in FIGS. 13 and 14.

The switch contacts 75, 77 will be open in normal position and closed when the rotary switch 78 has rotated 180 degrees clockwise.

The batteries 71 have first and second battery contacts 85, 87. The first contact 85 is always connected to a switch circuit 80 to an input 89. The second contact 87 of the battery 71 is connected to the second switch contact 77 of the rotary switch 78. The first switch contact 75 of the rotary switch 78 is connected to the second input 91 of the switch circuit 80.

When the bar 14 is unlocked, the switch contacts 75, 77 of the rotary 78 switch are opened. In this situation no current flows from the batteries to the switch circuit 80 and the LED 82 is off as illustrated in FIG. 13.

When the key 59 of the lock mechanism 63 is turned 180 degrees the prolongation bar 92 is present in one of the sequence of shallow ridges 58 of bar 14 through the opening 67. The prolongation bar recess 94 is in the opposite of a ridge of the sequence of shallow ridges 58 belong to the bar 14. In this case the prolongation bar 92 of lock mechanism 63 will lock the bar 14. At the same time when the key has been turned 180 degrees clockwise the rotary switch 78 has rotated 180 degrees too, closing the first and second switch contacts 75; 77 allowing to flux the current from the batteries 71 to the switch circuit 80 and the LED 82 starting to flash as illustrated in FIG. 14.

The prolongation bar 92 of the lock mechanism 63 is located in the lock 16 a distance from the spherical bearing 68 exactly the distance between the sequence of shallow ridges 58 of the bar 14 as illustrated in FIG. 12. The function of the spherical bearing 68 is to stop the bar 14 in the right position allowing to rotate the key 59 of the lock mechanism 63.

The Universal Steering Wheel Lock has two adjustments to lock the steering wheel of a vehicle. The locking mechanism 39 operates as a fine adjustment and the lock 16 operates as a gross adjustment and final lock.

The adjustment for locking the steering wheel using the lock 16 and the bar 14 goes from one ridge of the sequence of shallow ridges 58 to an adjacent ridge of the sequence of shallow ridges 58 in the bar 14 as illustrated in FIG. 12.

The other locking mechanism 39 illustrated in FIG. 6 and FIG. 7 adjusts the Universal Steering Wheel lock with more precision because every time the bar 14 screwing up a whole turn one thread of the screw shape 52 will advance inside the locking mechanism 39. This advance is at least five (5) times smaller than the steps between the sequence of shallow ridges 58 of the bar 14.

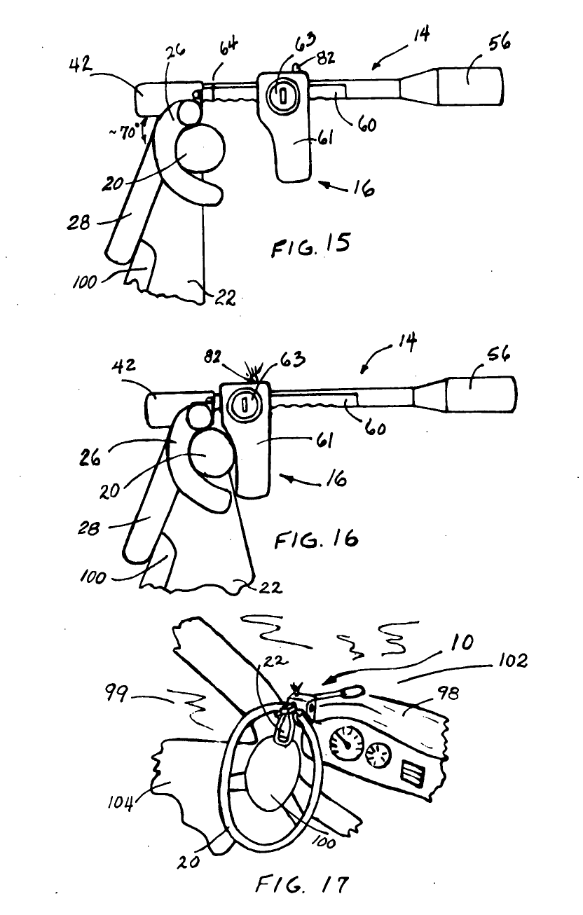

The procedure for the adjustment of the Universal Steering Wheel Lock to the steering wheel of a vehicle is described as follows. The Universal Steering Wheel Lock 10 is inserted in the steering wheel 18 as illustrated in FIGS. 1 and 15. The lock 16 is moved to the steering wheel 18 as illustrated in FIG. 16. If the lock 16 is in position to lock, allowing turning the key 59, but it doesn't adjust firmly the steering wheel 18 then the user starts to screw up the bar 14 between the first and second marks 62, 64 of the bar 14 as illustrated in FIG. 5. The distance the first and second marks 62, 64 matches the distance between the ridges of the sequence of shallow ridges 58.

Once the lock 16 is moved back again to the steering wheel 18 and gets the position able to lock firmly against the steering wheel 18 then the lock 16 is moving back momentarily allowing one to insert the stopper 54 in the stopper cavity 46 locking the bar 14.

The final lock is reached when moving back the lock 16 against the steering wheel 18 and turning the key 59 180 degrees clockwise. The Universal Steering Lock is looked in the steering wheel 18 of a vehicle.

When is locked the space between the front side of locking mechanism 39 and the lock 16 is smaller than the length of the stopper 54 making unable to remove the stopper 54. This procedure is made only one time to adapt the Universal Steering Wheel to a specific steering wheel of a vehicle. The next time the user wants to lock the steering wheel only will be necessary to move the lock 16 against the steering wheel 18 and turn the key 59 180 degrees clockwise. In this moment the Universal Steering Wheel Lock has locked the steering wheel 18 of a vehicle and the LED 82 starts trashing.

The bar 14 of the Universal Steering Wheel Lock firmly attached to the steering wheel 18 obstructs the rotation of the steering wheel 18 when the bar 14 starts to touch the dashboard 98 of the vehicle, as illustrated in FIG. 17.

The U shape of the hook 18 will be on the top of the horn 100 of the steering wheel provoking a horn sound when someone other than car's owner tries to remove the lock as illustrated in FIGS. 17 and 23. FIG. 17 illustrates the Universal Steering Wheel installed in the steering wheel 18 of a vehicle.

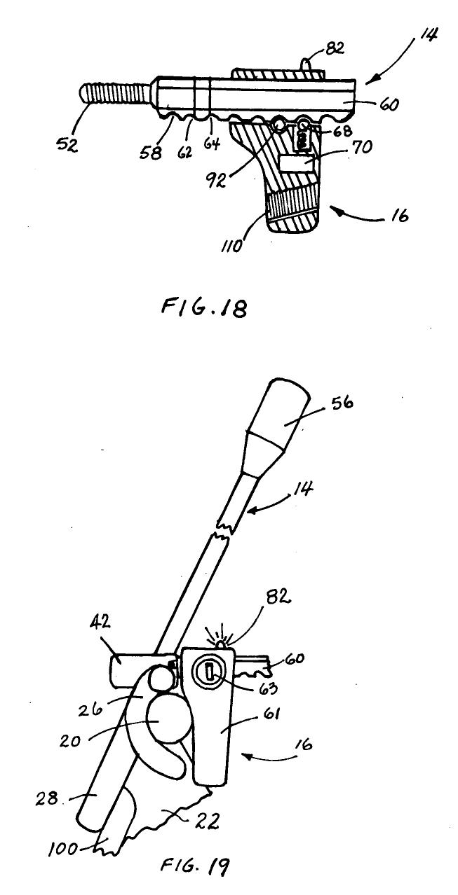

A version of the Universal Steering Wheel Lock is shown in the FIGS. 18, 19 and 20. In this embodiment, the bar 14 has been cut keeping only the small section with the truncated area 60 and the sequence of shallow ridges 58 for locking purposes, as illustrated in FIG. 18. The bar 14 is now attached firmly on the top of locking mechanism 39 as illustrated in FIG. 19. The lock 16 is touching the arm 22 avoiding the movement of the Steering Wheel Lock 10.

If the lock 16 does not reach the arm 22 of the steering wheel when is locked, the lock 16 has a threaded adjustment hole 110 and special shape 116 as illustrated in FIG. 8, 9 and 12.

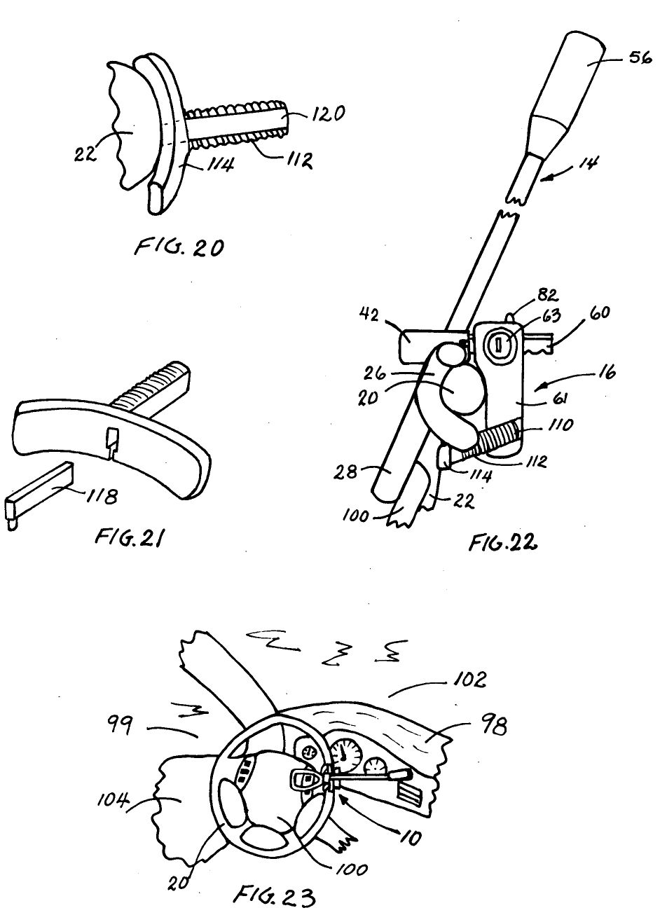

An adjustment screw 112 with a truncated area 120 is illustrated in FIG. 20. The adjustment screw 112 has a bended T head 114. When the adjustment screw 112 rotates in the threaded adjustment hole 110, the T head 114 will be closer to the arm 22. In this moment the lock 16 is moved back to allow inserting the rectangular bar 118 illustrated in FIG. 21 in the rectangular shape 116 avoiding rotation of the adjustment screw 112 inside the lock 16. This procedure is made only one time to adjust the Universal Steering Wheel Lock to specific arm shape of the steering wheel.

For now on the next time to lock the steering wheel only will be necessary to move the lock 16 against the steering wheel 18 and turn the key 59 180 degrees.

The function of the adjustment screw 112 is illustrated in FIG. 22 avoiding any rotation of the steering wheel lock through the cylindrical part of the steering wheel. In this version the bar 14 of the Universal Steering Wheel Lock will obstruct the rotation of the steering wheel 18 when the bar 14 starts to touch the front window of the car 102, the roof of the car, the glass of the driver's door 99 or the driver's door of the car 104, as illustrated in FIG. 23.

The Universal Steering Wheel Lock is normally made of metal mainly hardened steel and covered some areas of finished chrome and colored rubber coating for preservation. Fluorescent paints can be used for better visualization and label logo of the product.

I claim:

1. A steering wheel lock comprising:
a triple hook having,
a bended bar attached between first and second U-shaped hooks, the first and second U-shaped hooks respectively have first and second ends following the arc shape of a vehicle steering wheel, whereby the bended bar abuts the horn at the center of the vehicle steering wheel, and the U-shaped hooks wrap around the wheel section of the steering wheel;
a bar receiving mechanism attached to the triple hook, the bar receiving mechanism having,
a lock mechanism attached to the first and second ends of the first and second U-shaped hooks, whereby the bar receiving mechanism is positioned approximately 70 degrees in reference with the side of the bended bar directly opposite the steering wheel to compensate the inclination of the steering wheel in a vehicle;
a lock box having,
a bar cavity with an internal threaded orifice abutting the bar cavity along its longitudinal axis,
a stopper cavity,
a stopper knob cavity,
a stopper having a stopper knob perpendicular at one end of the stopper, whereby the stopper and stopper knob have such size and dimension to substantially fill the stopper cavity and a stopper knob cavity;
a bar fixable to the lock box, the bar having,
at one end a screw shape with a thread to be screw up in the bar cavity gradually until the desired position,
at the other end of the bar a rubber grip, and a sequence of shallow ridges substantially along the length of the bar on one edge,
a truncated area along a second side of the bar perpendicular and adjacent to the sequence of shallow ridges,
first and second marks on the truncated area;
a lock having,
a lock housing,
a truncated hole with a spherical bearing, whereby the bar slides through the truncated hole,
an indicator recess with a rotary switch having first and second switch contacts whereby the switch contacts will be open in normal position and closed when the rotary switch has rotated 180 degrees clockwise, a switch circuit, an LED, a recess lid and a screw to secure the recess lid over the indicator recess,
a key lock mechanism, with a prolongation bar having a prolongation bar recess, allowing the bar to slide through the truncated hole when the prolongation bar recess is unlocked, the prolongation bar has a rotary switch cavity at the end with a half moon shape to insert the half moon bar belongs to the rotary switch, the prolongation bar is a distance from the spherical bearing the distance between the sequence of shallow ridges;
a case having batteries therein, a case lid secured over the case with a groove to hold the batteries, the batteries have first and second battery contacts, whereby the first contact is always connected to a switch circuit to an input, the second contact of the battery connects to the second switch contact of the rotary switch,
a spring cavity with a spring and a spherical bearing, a set of flanges to avoid the exit of the spherical bearing from the spring cavity.

2. The steering wheel lock of claim 1, wherein the triple hook is hardened steel covered with a rubber finish to avoid any damage to the steering wheel.

3. The steering wheel lock of claim 1, wherein the lock has a curved impression to accommodate the circular wheel section of the steering wheel and a dimple to accommodate the arm.

4. The steering wheel lock of claim 1, further comprising: a truncated adjustment screw with a bended T head, wherein a threaded adjustment hole on the lock receives the truncated adjustment screw allowing a user to tighten or loosen the degree to which the adjustment screw protrudes from the lock and contacts the arm of the user's steering wheel, and a rectangular bar for fixing the truncated adjustment screw in a desired position.

5. A steering wheel lock comprising:
a triple hook having,
a bended bar attached between first and second U-shaped hooks, the first and second U-shaped hooks respectively have first and second ends following the arc shape of a vehicle steering wheel, whereby the bended bar abuts the horn at the center of the vehicle steering wheel, and the U-shaped hooks wrap around the wheel section of the steering wheel;
a bar receiving mechanism attached to the triple hook, the bar receiving mechanism having,
a lock mechanism attached to the first and second ends of the first and second U-shaped hooks, whereby the bar receiving mechanism is positioned approximately 70 degrees in reference with the side of the bended bar directly opposite the steering wheel to compensate the inclination of the steering wheel in a vehicle;
a lock box having,
a bar cavity with an internal threaded orifice abutting the bar cavity along its longitudinal axis,
a stopper cavity,
a stopper knob cavity,
a stopper having a stopper knob perpendicular at one end of the stopper, whereby the stopper and stopper knob have such size and dimension to substantially fill the stopper cavity and a stopper knob cavity;
a bar fixable to the lock box aligned with the bended bar of the triple hook at one end and at the other end of the bar a rubber grip,
a truncated area having a sequence of shallow ridges, along a longitudinal side, at one end a screw shape with a thread to be screw up in the bar cavity gradually until the desired position,
first and second marks on the truncated area;
a lock having,
a lock housing,
a truncated hole with a spherical bearing, whereby the bar slides through the truncated hole,
an indicator recess with a rotary switch having first and second switch contacts whereby the switch contacts will be open in normal position and closed when the rotary switch has rotated 180 degrees clockwise, a switch circuit, an LED, a recess lid and a screw to secure the recess lid over the indicator recess,
a key lock mechanism, with a prolongation bar having a prolongation bar recess, allowing the bar to slide through the truncated hole when the prolongation bar recess is unlocked, the prolongation bar has a rotary switch cavity at the end with a half moon shape to insert the half moon bar belongs to the rotary switch, the prolongation bar is a distance from the spherical bearing the distance between the sequence of shallow ridges;
a case having batteries therein, a case lid secured over the case with a groove to hold the batteries, the batteries have first and second battery contacts, whereby the first contact is always connected to a switch circuit to an input, the second contact of the battery connects to the second switch contact of the rotary switch,
a spring cavity with a spring and a spherical bearing, a set of flanges to avoid the exit of the spherical bearing from the spring cavity.

6. The steering wheel lock of claim 5, wherein the triple hook is hardened steel covered with a rubber finish to avoid any damage to the steering wheel.

7. The steering wheel lock of claim 5, wherein the lock has a curved impression to accommodate the circular wheel section of the steering wheel and a dimple to accommodate the arm.

8. The steering wheel lock of claim 5, further comprising: an adjustment screw with a bended T head, wherein a threaded adjustment hole on the lock receives the adjustment screw allowing a user to tighten or loosen the degree to which the adjustment screw protrudes from the lock and contacts the arm of the user's steering wheels and a rectangular bar for fixing the truncated adjustment screw in a desired position.
